(19) United States
(12) Patent Application Publication
(10) Pub. No.: US 2015/0091727 A1
(43) Pub. Date: Apr. 2, 2015

(54) MOBILE DEVICE LOCATOR

(71) Applicant: LAWRENCE LEE MOSES, Beverly Hills, CA (US)

(72) Inventor: LAWRENCE LEE MOSES, Beverly Hills, CA (US)

(21) Appl. No.: 14/044,274

(22) Filed: Oct. 2, 2013

(51) Int. Cl. G08B 21/24

(52) U.S. Cl. CPC G08B 21/24
USPC 340/539.32

(57) ABSTRACT

A mobile device locator is disclosed. The locator system includes a receiver associated with a mobile device and a locator device. The locator device sends an interrogative signal to the receiver, which emits a return signal. The locator device calculates the distance from the locator device to the receiver and activates an indicator to show the distance.

### BACKGROUND

The embodiments herein relate generally to locator devices that may be used to assist in finding a misplaced mobile device, such as, e.g,, a smartphone, a cellular phone, a tablet, a laptop, and so on.

Mobile devices are central to modern life, but their very mobility and portability makes them prone to being misplaced, especially by harried, distracted, or busy individuals. Currently, locating a misplaced device is limited to manual methods. Typically, a user relies on his own unaided eyesight to locate a misplaced device. If this technique fails, the user may resort to calling or otherwise activating an alert (such as a new email notification) on the device. These alerts often include audio and/or visual components that may temporarily make the device easier to locate. However, the beneficial effects last only as long as the alert itself. This requires the user to repeatedly activate the alert. In addition, this technique only works if the misplaced device will generate an alert. For example, a smartphone set to “vibrate only” may not generate an audio or visual alert when a new phone call or email message is received.

Additionally, tracking apps are available for many devices, but these apps are limited by scale. They can tell a user if his device has been stolen (and often include a feature to remote erase the device) or if he has left it at his home or office. These apps, however, lack the precision to assistant the user in locating his misplaced device within his home or office.

### SUMMARY

According to one embodiment of the present invention, a system assists a user with locating a misplaced mobile device by indicating a distance between a locator device and a receiver associated with the mobile device. The system includes a receiver and a locator device. The receiver is associated with a mobile device and configured to emit a return signal after receiving an interrogative signal. The locator device assists the user in locating the mobile device, and it includes an activation button, an indicator, and a deactivation button. The activation button is located on a surface of a housing and configured to cause the locator device to start emitting an interrogative signal. The indicator is located on a surface of the housing and includes a light, a speaker, or both. The indicator is configured to emit a periodic signal that can be perceived by the user. The frequency of the signal corresponds to a distance from the locator device to the receiver associated with the mobile device. The deactivation button is located on a surface of the housing. It is configured to cause the locator device to stop emitting the interrogative signal. The locator device is configured to be used to locate the receiver associated with the mobile device by emitting the interrogative signal, receiving the return signal from the receiver, calculating a distance from the locator device to the receiver associated with the mobile device, activating the indicator at a frequency corresponding to the distance, and adjusting the frequency of the indicator when the distance changes.

In addition, the mobile device may include the receiver. The system may also include a case configured to be attached to the mobile device, and the case may include the receiver.

According to an alternate embodiment of the present invention, a system assists a user in locating a misplaced mobile device by activating an ongoing alet associated with the mobile device. The system includes a receiver associated with the mobile device and a locator device. The receiver is configured to activate an ongoing alert while receiving a signal and to deactivate the ongoing alert when it stops receiving the signal. The ongoing alert includes an audio alert, a visual alert, or both. The locator device assists the user in locating the mobile device and includes an activation button and a deactivation button. The activation button is disposed on a surface of a housing and is configured to cause the locator device to start emitting a signal. The deactivation button is located on a surface of the housing and is configured to cause the locator device to stop emitting the signal. The locator device is configured to be used to locate the receiver associated with the mobile device by emitting a signal, thereby causing the receiver to activate the ongoing alert.

In addition, the ongoing alert may be generated by the mobile device or it may be generated by the receiver. The mobile device may include the receiver. The system may also include a case configured to be attached to the mobile device, and the case may include the receiver. Even if the system includes a case with the receiver, the alert may be generated by the mobile device. The receiver may be configured to communicate with the mobile device using a wireless communication protocol. The receiver may also be configured to communicate an instruction to the mobile device to generate the ongoing alert when the receiver receives the signal.

### BRIEF DESCRIPTION OF THE FIGURES

The detailed description of some embodiments of the present invention is made below with reference to the accompanying figures, wherein like numerals represent corresponding parts of the figures.

FIG. 1 shows a perspective view of one embodiment of the present invention.

### DETAILED DESCRIPTION OF CERTAIN EMBODIMENTS

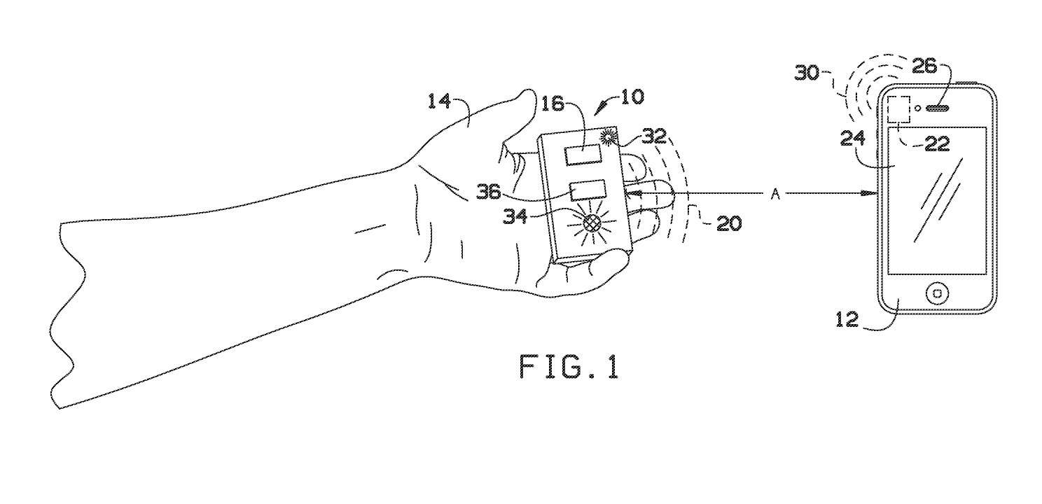

By way of example, and referring to FIG. 1, one embodiment of the present invention comprises a locator device 10 that may be used to assist in finding a misplaced mobile device 12. When a user 14 wants to locate a misplaced device 12, he may press an activation button 16 on the locator device 10. The device 10 may emit a signal 20, which may be received by a receiver 22 associated with the mobile device 12. The receiver 22 may be integrated or included in the mobile device 12 itself, or the receiver 22 may be integrated or included in a case, cover, or other accessory associated with the mobile device 12. After receiving the signal 20 from the locator device, the receiver 22 may activate an alert. The alert may be ongoing. For example, the alert may begin when the receiver 22 receives the signal 20 and continue until the receiver 22 no longer receives the signal 20. The alert may be intermittent. For example, the alert may be active for 5 seconds and be inactive for 5 seconds. This pattern may continue until the receiver 22 is no longer receiving the signal 20. The pattern may be pre-selected by the user, or the user may select the pattern using the locator device 10. The alert may include auditory components, visual components, or both. For example, the receiver 22 may include a light (not shown), speaker (not shown), or both. The alert may include flashing the light, producing a beep or other tone from the speaker, or both. Additionally or alternatively, the receiver 22 may activate an alert on the device after receiving the signal 20 from the locator device. The alert may include, for example, flashing lights or colors on a device screen 24; an audio tone, beep, klaxon, or the like played from a device speaker 26; and so on. The receiver 22 may be configured so that a visual alert, such as, e.g., a flashing light or an illuminated screen on the mobile device 12, may be activated only when the locator device 10 is within close proximity to the mobile device 12. For example, the visual alert may only activate when the locator device 10 is within 15 feet of the mobile device 12. Other ranges are contemplated, and the range may be selectable by the user 14. By activating the visual alert when the locator device 10 is in close proximity, the system may conserve battery power in the receiver 22, the mobile device 12, or both. A receiver 22 that is not integrated into the device 12 may use a wireless communication protocol, such as, e.g., Bluetooth®, near-field communication (NFC), or the like, to activate an alert on the device 12.

The receiver 22 may include a transponder. For example, after receiving the signal 20, which may include an interrogative signal, the receiver 22 may emit a return signal 30. The transponder may include a passive transponder powered by the signal 20 from the locator device. A passive transponder requires no power source of its own to emit the return signal 30. Thus, the receiver 22 may not need batteries, and it may operate even if the mobile device 12 is out of power. For example, the receiver 22 may include a radio-frequency identification (RFD) chip or tag as its transponder. The locator device 10 may use the return signal 30 to determine a distance (represented, e.g., by arrow A in FIG. 1) from the locator device 10 to the mobile device 12. The locator device 10 may include an indicator, such as, e.g., a light 32, a speaker 34, or the like. The indicator may emit a signal that can be perceived by the user, and the signal may be emitted at intervals corresponding to the distance from the locator device 10 to the mobile device 12. For example, the indicator may include a light 32, and the light 32 may flash at regular intervals corresponding to the distance, so that a longer time between flashes indicates that the mobile device 12 is farther way and a shorter time indicates that the device 12 is closer. When the locator device 10 is in very close proximity to the mobile device, the light 32 may illuminate or appear to illuminate constantly. The indicator may include, for example, a speaker 34, and the speaker 34 may emit a beep or other tone at regular intervals corresponding to the distance between the locator device 10 and the mobile device 12. A longer time between beeps or tones indicates that the mobile device 12 is farther way, and a shorter time indicates that the device 12 is closer. When the locator device 10 is in very close proximity to the mobile device, the speaker 34 may beep or appear to beep constantly. Since the locator device 10 indicates the distance to the misplaced mobile device 12, the user 14 can move around with the locator device 10, use it to determine whether he is farther from or closer to the misplaced mobile device 12, move closer to the mobile device 12, and eventually home in on its location. Once the misplaced mobile device 12 has been located, the locator device 10 may be deactivated by pressing a deactivation button 36 on the locator device 10.

The locator device 10 may be capable of broadcasting a signal 20 to a mobile device 12 up to substantially 100 yards (300 feet) away. If the receiver 22 includes a transponder, the locator device 10 may be capable of receiving a signal 30 from a mobile device 12 up to substantially 100 yards (300 feet) away.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A system for assisting a user in locating a misplaced mobile device by indicating a distance between a locator device and a receiver associated with the mobile device, the system comprising:
a receiver associated with a mobile device and configured to emit a return signal after receiving an interrogative signal;
a locator device for assisting a user in locating the mobile device, the locator device comprising:
an activation button disposed on a surface of a housing and configured to cause the locator device to start emitting an interrogative signal;
an indicator disposed on a surface of the housing and comprising at least one of a light and a speaker, the indicator configured to emit a periodic signal that can be perceived by the user, the frequency of the signal corresponding to a distance from the locator device to the receiver associated with the mobile device; and
a deactivation button disposed on a surface of the housing and configured to cause the locator device to stop emitting the interrogative signal;
wherein the locator device is configured to be used to locate the receiver associated with the mobile device by emitting the interrogative signal, receiving the return signal from the receiver, calculating a distance from the locator device to the receiver associated with the mobile device, activating the indicator at a frequency corresponding to the distance, and adjusting the frequency of the indicator when the distance changes.

2. The system of claim 1, wherein the mobile device includes the receiver.

3. The system of claim 1, further comprising:
a case configured to be attached to the mobile device;
wherein the case comprises the receiver.

4. A system for assisting a user in locating a misplaced mobile device by activating an ongoing alert associated with the mobile device, the system comprising:
a receiver associated with a mobile device and configured to activate an ongoing alert while receiving a signal, the ongoing alert comprising at least one of an audio alert and a visual alert, the receiver further configured to deactivate the ongoing alert when the receiver stops receiving the signal; and
a locator device for assisting a user in locating the mobile device, the locator device comprising:
an activation button disposed on a surface of a housing and configured to cause the locator device to start emitting a signal; and
a deactivation button disposed on a surface of the housing and configured to cause the locator device to stop emitting the signal;
wherein the locator device is configured to be used to locate the receiver associated with the mobile device by emitting a signal, thereby causing the receiver to activate the ongoing alert.

5. The system of claim 4, wherein the ongoing alert is generated by the mobile device.

6. The system of claim 4, wherein the ongoing alert is generated by the receiver.

7. The system of claim 4, wherein the mobile device includes the receiver.

8. The system of claim 4, further comprising:
a case configured to be attached to the mobile device;
wherein the case comprises the receiver.

9. The system of claim 8, wherein the ongoing alert is generated by the mobile device.

10. The system of claim 9, wherein
the receiver is configured to communicate with the mobile device using a wireless communication protocol; and
the receiver is further configured to communicate an instruction to the mobile device to generate the ongoing alert when the receiver receives the signal.
